(19) United States
(12) Patent Application Publication
(10) Pub. No.: US 2009/0308270 A1
(43) Pub. Date: Dec. 17, 2009

(54) DOCTOR BLADE

(75) Inventors: Marty L. Cansler, Lincolnton, NC (US); Daniel P. Cedrone, Huntersville, NC (US)

Correspondence Address: MATTHEW R. JENKINS, ESQ., 2310 FAR HILLS BUILDING, DAYTON, OH, 45419, US

(73) Assignee: DAETWYLER SWISSTEC AG, Bleienbach (CH)

(21) Appl. No.: 12/438,800

(22) PCT Filed: Aug. 29, 2006
(86) PCT No.: PCT/CH2006/000467

§ 371 Date: Jul. 6, 2009

(51) Int. Cl. B41F 9/10; B29C 65/48

(52) U.S. Cl. 101/169; 156/60

(57) ABSTRACT

A doctor blade, in particular for metering of inks and coatings from an engraved surface, has a flat oblong base body and a blade region with a working edge being formed at one of the longitudinal sides of the base body. The blade region is at least partially made of a plastics material, whereas the working edge is formed of the plastics material. The base body is made from a reinforced plastics material. The opposing main outer surfaces of the base body are constituted by plastic layers made from a first material, where at least one inner layer made from a second material having a higher rigidity than the first material is provided in between the plastic layers.

### TECHNICAL FIELD

The invention relates to a doctor blade, in particular for metering of inks and coatings from an engraved surface, the doctor blade having a flat oblong base body and a blade region with a working edge being formed at one of the longitudinal sides of the base body. The invention further relates to a method for manufacture of a doctor blade.

### BACKGROUND ART

In the printing industry, doctor blades are used in particular for the metering of inks and coatings from an engraved surface, e.g. from the surface of a printing cylinder: After the recessed cells of the cylinder are covered with ink, a blade must wipe away the excess ink before it reaches the printing nip. The correct application of the doctor blade is critical in gravure and flexographic printing.

Doctor blades are consumables. They are periodically replaced. It is therefore favorable if doctor blades are cost-efficient and if their handling is as safe as possible.

Present day doctor blades mainly come in two forms, namely metallic and polymeric (non-metallic). Metallic blades, usually made of carbon steel, offer the following benefits:

They have a superior rigidity in thin sections;

they are easy to manufacture even if tight tolerances have to be observed;

they are able to support a very thin edge;

they provide clean doctoring (sharp and clean wipe);

they have a superior flatness; and

they do not exhibit any memory effects.

However, in comparison with non-metallic blades metallic blades also have the following negatives:

Their friction with the surface to be doctored is higher;

they are abrasive to the opposing surface;

they develop sharp edges when worn which is a point of potential danger;

they oxidize and therefore develop rust;

the debris from wear of the doctor blade contaminates the media;

they do not have any sealing properties in and of itself; and

the material is not readily available.

Consequently, non-metallic blades offer the following benefits:

Their friction with the surface to be doctored is low;

they are safer than metallic blades;

they do not develop sharp edges when worn;

they are non-abrasive;

their debris is not harmful to the media;

the material is readily available in stock;

the material has inherent sealing properties; and

there is no oxidation.

But also non-metallic doctor blades have negative properties:

They are more expensive than steel;

they have a low modulus of stiffness in thin sections which leads to deformations of the blade that hamper the precise control of the doctoring process;

they have an inferior flatness and tend to be wavy;

they introduce additional manufacturing challenges in producing a preferred edge;

they cannot support a thin edge well;

clean doctoring is limited due to the required thickness of the material; and

the material retains memory.

The main reasons for using metallic blades are their rigidity and flatness. However, using metallic blades means to put up with safety problems as well as with abrasion to itself and the surface to be doctored. Correspondingly, the users of non-metallic blades focus on safety and low abrasion, putting up with low rigidity and inferior flatness of the working edge.

Depending on the task to be performed, metallic or non-metallic doctor blades are preferred. Therefore, it has been proposed to modify blade holders to accommodate both metallic and non-metallic blades such that metallic or non-metallic blades may be flexibly used subject to the specific task to be performed.

Recent developments and designs have attempted to counter some of the negative aspects of both types of blades by applying coatings to the blades and by manufacturing the surface of the rollers with different materials (chrome and ceramic). These measures extend the life of the components and enable lower friction values. Additives have also been introduced into the media for their properties of lubricity and prevention of oxidation.

As an example, the publication JP 4-296556 (Toppan Printing Co. Ltd.) relates to a doctor blade that is coated with a thin coating of an ink repellent material such as silicone resin, fluorine resin, a polymer containing a long chain acrylic group, polyolefin, alkyd resin, shellac, silicone containing fluorine, etc.

Furthermore, some doctor blade designs have been proposed that include structural elements both made from metal as well as from a plastics material:

The DE 28 23 603 (Max Dätwyler & Co.) describes a doctor blade arrangement that comprises a metal doctor blade having a plastic cladding. The cladding constitutes outer surfaces of the doctor blade and is firmly connected to the doctor blade in a base body region. Before the doctor blade is clamped to the doctor blade holder the cladding mainly serves as a packaging for protecting the doctor blade as well as the user mounting the blade in the printing press. After the doctor blade has been clamped to the doctor blade holder a removable portion of the cladding is removed in order to uncover the metallic working edge. During operation of the doctor blade the remaining portion of the cladding serves for the damping of vibrations of the doctor blade.

U.S. Pat. No. 2,052,679 (Wainwright et al.) relates to a doctor blade for doctoring gravure cylinders or plates. The doctor blade features a working blade from a plastics material such as synthetic resin or cellulose derivative materials. The entire doctor blade may be manufactured of the plastics material, whereas advantageously the plastics material is reinforced to within a short distance of the working edge with a metal reinforcement. The metal reinforcement is a metal layer that is arranged on one of the main outer sides of the plastic blade body.

However, these designs mitigate only some specific disadvantages of metallic and/or non-metallic doctor blades, respectively.

### SUMMARY OF THE INVENTION

It is the object of the invention to create a doctor blade pertaining to the technical field initially mentioned that combines benefits of both metallic and non-metallic doctor blades while reducing or eliminating negative aspects of both.

The solution of the invention is specified by the features of claim 1. According to the invention the blade region is at least partially made of a plastics material, the working edge, i.e. the region of the doctor blade that is in contact with the surface to be doctored, being formed of the plastics material, whereas the base body is made from a reinforced plastics material. The opposing main outer surfaces of the base body are constituted by plastic layers made from a first material, at least one inner layer made from a second material having a higher rigidity than the first material being provided in between said plastic layers.

The doctor blade therefore incorporates structural components of different rigidities, whereas a plastic working edge is provided. The rigid inner layer, which may constitute a core of the doctor blade, is accommodated in between plastics layers, the outer surfaces of the doctor blade being constituted by the plastics material. Thereby a doctor blade is provided that is at the same time rigid and non-abrasive. The wear debris is not harmful to the media and the doctor blade provides sealing qualities. Due to the fact that the main outer surfaces of the doctor blade are constituted by the plastics material the doctor blade is not subject to rusting or oxidation and the safety for the user is enhanced.

Preferably, the inner layer is metallic, e.g. made from steel. Alternatively, the inner layer may be manufactured from a non-metallic rigid material such as e.g. fiberglass or carbon fiber.

Preferably, a thickness of the blade region is smaller than a thickness of the base body. This allows for providing a rigid doctor blade with a flat blade region.

Advantageously, the entire blade region is formed of the plastics material, i.e. the inner layer does not extend to the working edge but there is a region of the doctor blade, adjacent to the working edge that is entirely made of the plastics material. This allows for providing a non-metallic working edge that has all the advantages of known non-metallic working edges and that may be formed and manufactured like the working edges of known non-metallic doctor blades.

Alternatively, the inner layer substantially extends into the region of the working edge, i.e. the working edge is constituted by the plastics material which is directly supported by the respective region of the rigid inner layer. The blade region is designed in such a way that the working edge is always constituted by the plastics material, even after wear of the doctor blade.

Preferably, the inner layer is firmly adhered to the plastic layers. This enables a high rigidity as well as a high durability of the doctor blade. Due to the firm attachment all forces acting on the outer plastic surfaces may be transmitted to the rigid base body. Alternatively, the inner layer is not attached to the plastic layers but held within the plastic layers due to the geometry of the plastic layers, i.e. the plastic layers are formed in such a way that a retaining space is formed, in which the base body is retained. It is possible to manufacture a doctor blade that incorporates such a retaining form of the plastic layers as well as the firm attachment of the inner layer to the plastic layers.

To firmly attach the inner layer to the plastic layers, these elements are advantageously adhered together. This allows for having large attachment surfaces between the layers and therefore for optimally distributing the forces to be transferred from one layer to the other. Alternative attachment means may be used, such as rivets, or the plastic layers as well as the metallic base body feature corresponding form-fit surfaces, e.g. interacting dovetail profiles.

In a preferred embodiment of the invention, the plastic layers project over the longitudinal side of the base body neighboring the work blade and the projecting regions of the plastic layers are joined together. This allows to easily manufacturing a doctor blade having a plastic blade region as well as a metallic base body.

Preferably, the projecting, joined plastic layers constitute the blade region with the working edge. Thereby, the entire doctor blade may be essentially built up from three components, namely from an oblong rigid inner body (core) as well as from two plastic layers of the same extension having a base area that is larger than that of the inner body and that are coextensively provided on both the opposing main surfaces of the inner body, in such a way that a region of the plastic layers is projecting over the longitudinal side of the inner body. After joining the projecting regions of the plastic layers a blade region is formed where a plastic working edge may be easily formed by grinding.

Advantageously, the plastic layers consist of an oriented polyester film. Corresponding films of suitable thicknesses are commercially available at comparably low costs. They are dimensionally stable, exhibit a high tensile strength and are especially well suited for being laminated.

Alternatively, other plastics materials are used, e.g. plastics materials reinforced with fibers (such as carbon or glass fibers).

Preferentially, a thickness of each of the plastic layers amounts at least to a thickness of the inner layer. The plastic layers are not just coatings of the metal core but structural elements of their own. In particular, the thickness of each of the plastic layers is in the range of 0.1-0.5 mm, in particular in the range of 0.15-0.4 mm, whereas the thickness of the inner layer is in the range of 0.05-0.3 mm, in particular in the range of 0.1-0.25 mm. These layer thicknesses allow for the production of doctor blades that are at the same time rigid as well as flat. If the blade region is constituted by two joined plastic layers the given thicknesses allow for forming a working edge with optimum operation properties for metering of inks and coatings from engraved surfaces.

For special purposes it is possible to vary the layer thicknesses as well as the ratios of layer thicknesses.

A doctor blade according to the invention may be manufactured by

a) providing a flat oblong core having at least one inner layer;
b) arranging two plastic layers on opposing main surfaces of the core, in such a way that the plastic layers project over a longitudinal side of the core;
c) firmly adhering the plastic layers to the core;
d) adhering together the plastic layers in the projecting region.

The core may be constituted by a single one-piece element having an increased rigidity or by a composite element that comprises at least one reinforcement layer that is able to provide additional mechanical stability to the core.

Preferably, the plastic layers and the inner layer (or the core) are laminated together, i.e. the steps c) and d) are performed by a laminating process, i.e. an adhesive layer is provided in between the layers and subsequently the layers are joined together using pressure and heat. This is advantageously done by running the un-laminated materials through a set of heated platens, heated rollers and/or rollers with a close heat source. Laminating is a cost-effective process that allows for a firm attachment of neighboring layers as well as for high production rates.

Alternatively, spray adhesives, epoxy resins which can be spread on the surfaces to be attached to each other or pressurized autoclaving techniques may be used.

Other advantageous embodiments and combinations of features come out from the detailed description below and the totality of the claims.

### BRIEF DESCRIPTION OF THE DRAWINGS

The drawings used to explain the embodiments show:

FIG. 1 A cross-sectional view of a first embodiment of a doctor blade according to the invention;

FIG. 2 a cross-sectional view of a second embodiment of a doctor blade according to the invention; and

FIG. 3A-C a schematic representation of an inventive method for manufacture of a doctor blade.

In the figures, the same components are given the same reference symbols.

### PREFERRED EMBODIMENTS

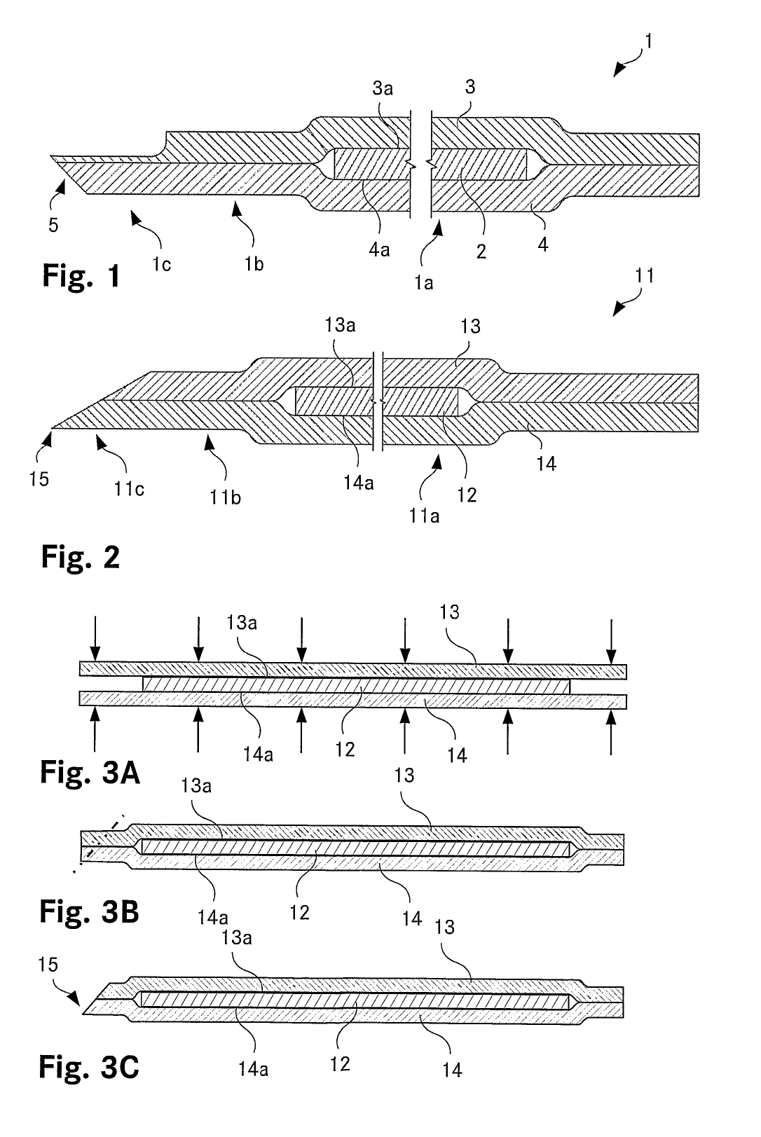

The FIG. 1 shows a cross-sectional view of a first embodiment of a doctor blade according to the invention, along a plane perpendicular to the longitudinal extension of the doctor blade. The view is schematic; the dimensions are not to scale. The doctor blade 1 comprises a core body 2 made from steel as well as two plastic layers 3, 4 arranged on both sides of the core body 2. The core body 2 has an elongated form, the length of it corresponding to the length of the doctor blade 1 itself. It is to be noted, that the doctor blade 1 may be provided at a given length adapted to the machine it should be used in or at a fixed length (e.g. on a 100 m roll) for cutting off desired lengths.

The width of the core body 2 (i.e. the extension along the main plane of the doctor blade, perpendicular to the longitudinal extension) is about 40 mm; its thickness is about 0.15 mm. The plastic layers 3, 4 have a length that corresponds to the length of the core body 2, i.e. to the length of the entire doctor blade 1. Their width is about 45 mm, i.e. slightly larger than the width of the core body 2. The plastic layers 3, 4 are constituted by foils manufactured from oriented polyester. On their inner sides facing each other and the core body 2 the foils are provided with an adhesive coating 3a, 4a. The thickness of the plastic layers 3, 4 is about 0.18 mm, the thickness of the coatings 3a, 4a is about 0.05 mm. Therefore, the thickness of the doctor blade, measured in the region of the base body 1a, is about 0.61 mm.

Along the width of the plastic layers 3, 4 they project over both the longitudinal sides of the core body 2. The projecting portions of the layers 3, 4 are joined to each other on both sides of the core body 2. The attachment of the plastic layers 3, 4 to the core body 2 as well as to each other is effected by the adhesive coatings 3a, 4a that have undergone a laminating process together with the other elements of the doctor blade 1 (see below, FIGS. 3A-C).

On one side of the core body 2 the plastic layers 3, 4 are ground in such a way that a lamella region 1c exhibiting a beveled working edge 5 is formed. For this purpose, the thickness of the plastic layer 3 has been substantially reduced in a foremost portion such that the thickness of the lamella region 1c (edge thickness) amounts to about 0.30 mm. The other plastic layer 4 has been chamfered in such a way that its width is maximal at the contact surface with the other layer 3. An angle between the beveled working edge 5 and the main plane of the doctor blade 1 is about 50°. The width of the lamella region 1c (edge width) amounts to about 1.5 mm. In summary, the doctor blade 1 features three regions of different thickness, namely the base body 1a with a metallic layer sandwiched in between two plastic layers and having a first thickness, a transition region 1b adjacent to the base body 1a, being constituted of two adjacent plastic layers and having a second thickness which is smaller than the first thickness and the lamella region 1c again constituted of the two adjacent plastic layers, where the thickness of one of the layers is reduced, the lamella region 1c having a third thickness which is again smaller than the second thickness.

The FIG. 2 shows a cross-sectional view of a second embodiment of a doctor blade according to the invention. Again, the view is schematic and the dimensions are not to scale. The basic construction of the second embodiment corresponds to the first embodiment discussed above, in connection with FIG. 1. Like components of the second embodiment are denoted by reference numerals that correspond to the reference numerals of FIG. 1, increased by 10.

The doctor blade 11 comprises a core body 12 made from steel as well as two plastic layers 13, 14 arranged on both sides of the core body 12. The core body 12 has an elongated form, the length of it corresponding to the length of the doctor blade 11 itself. The width of the core body 12 (i.e. the extension along the main plane of the doctor blade, perpendicular to the longitudinal extension) is about 40 mm; its thickness is about 0.15 mm. The length of the plastic layers 13, 14 corresponds to the length of the core body 12, i.e. to the length of the entire doctor blade 11. Their width is about 45 mm, i.e. slightly larger than the width of the core body 12. The plastic layers 13, 14 are constituted by foils manufactured from oriented polyester. On their inner sides facing each other and the core body 12 the foils are provided with an adhesive coating 13a, 14a. The thickness of the plastic layers 13, 14 is about 0.18 mm, the thickness of the coatings 13a, 14a is about 0.05 mm. Therefore, the thickness of the doctor blade, measured in the region of the base body 11a, is about 0.61 mm.

Along the width of the plastic layers 13, 14 they project over the longitudinal sides of the core body 12, whereas the projecting portions of the layers 13, 14 are joined to each other on both sides of the core body 12. The attachment of the plastic layers 13, 14 to the core body 12 as well as to each other is effected by the adhesive coatings 13a, 14a that have undergone a laminating process together with the other elements of the doctor blade 1 (see below, FIGS. 3A-C).

On one side of the core body 12 both the plastic layers 13, 14 are chamfered such that a wedge-shaped working edge 15 is formed. The wedge angle amounts to about 30°. In summary, the doctor blade 11 features the base body 11a with a metallic layer sandwiched in between two plastic layers, a transition region 11b adjacent to the base body 11a, constituted by two adjacent plastic layers and having a thickness that is smaller than the thickness of the base body 11a and the chamfered edge region 11c again constituted by the two plastic layers, having a varying thickness.

The FIGS. 3A-C provide a schematic representation of an inventive method for the manufacture of a doctor blade, considering as example the second embodiment described above. Firstly, as depicted in FIG. 3A, an oblong metallic core body 12 is sandwiched in between two plastic foils (layers 13, 14). On their inner side, facing the core body 12, the foils are provided with an adhesive layer 13a, 14a. The width of the foils exceeds the width of the core body 12, and the layers 13, 14 are arranged such that they project over both longitudinal sides of the core body 12.

Next, the core body 12 as well as the plastic layers 13, 14 are laminated together: They are run through a set of heated platens, heated rollers and/or rollers with a close heat source. The transport speed amounts to 30 cm per minute at a pressure of 0.35 kg/cm². The temperature is adapted to the materials used as well as to the dimensions of the layers to be laminated, e.g. about 150° C. During the laminating process the projecting portions of both the layers 13, 14 are symmetrically deformed in such a way that they approach each other until their inner surfaces being provided with adhesive layers 13a, 14a contact each other in a large area (see FIG. 3B). In the course of lamination the layers 13, 14 are thereby tightly attached to the core body 12 as well as to each other.

Finally, one of the outer portions of the laminated workpiece constituted by the two plastic layers 13, 14 is worked by grinding. Both the plastic layers 13, 14 are chamfered such that a wedge-shaped working edge 15 is formed (see FIG. 3C). The result of the grinding (or sharpening) process is a perfectly straight and smooth working edge to rest against the printing cylinder.

It is to be noted that the foregoing description relates to just two examples of doctor blades according to the invention. However, various properties or features of the doctor blades may be chosen differently than in the context of these examples. For example, the absolute as well as the relative dimensions (widths, thicknesses etc.) may be varied in order to adapt the doctor blade to the specific application. The form of the doctor blade, especially of the edge region may as well be adapted to the concrete application. Similarly, the materials for both internal and external components of the doctor blade may be chosen differently. Depending on the materials used and on their dimensions the parameters characterizing the laminating process described above have to be adapted. It is even possible to use another type of process for attaching the plastic layers to the core body and to each other.

The two plastic layers may be constituted of different materials if e.g. the density or hardness of one of the layers is to be chosen differently from the respective parameters of the other layer. Furthermore, it is possible to employ additional plastic or metallic layers, especially in the region of the base body.

In summary, it is to be noted that the invention creates a doctor blade that combines benefits of both metallic and non-metallic doctor blades while reducing or eliminating negative aspects of both.

1. A doctor blade, in particular for metering of inks and coatings from an engraved surface, the doctor blade having a flat oblong base body, a blade region with a working edge being formed at one of the longitudinal sides of the base body, the blade region being at least partially made of a plastics material, the working edge being formed of the plastics material, and the base body (1a; 11a) being made from a reinforced plastics material, characterized in that the opposing main outer surfaces of the base body are constituted by plastic layers made from a first material, at least one inner layer made from a second material having a higher rigidity than the first material being provided in between said plastic layers.

2. The doctor blade as recited in claim 1, whereas the second material is metallic.

3. The doctor blade as recited in claim 1, whereas a thickness of the blade region is smaller than a thickness of the base body.

4. The doctor blade as recited in claim 1, whereas the entire blade region is formed of the plastics material.

5. The doctor blade as recited in claim 1, whereas the inner layer is firmly adhered to the plastic layers.

6. The doctor blade as recited in claim 5, whereas the plastic layers are adhered to the inner layer.

7. The doctor blade as recited in claim 6, whereas the plastic layers and the inner layer are laminated together.

8. The doctor blade as recited in claim 1, whereas the plastic layers project over the longitudinal side of the base body neighboring the work blade and wherein the plastic layers are joined together in the projecting region.

9. The doctor blade as recited in claim 8, whereas the joined plastic layers constitute the blade region with the working edge.

10. The doctor blade as recited in claim 1, whereas the plastic layers consist of an oriented polyester.

11. The doctor blade as recited in claim 1, whereas a thickness of each of the plastic layers amounts at least to a thickness of the inner layer.

12. The doctor blade as recited in claim 11, whereas the thickness of each of the plastic layers is in the range of 0.1-0.5 mm, in particular in the range of 0.15-0.4 mm, and whereas the thickness of the inner layer is in the range of 0.05-0.3 mm, in particular in the range of 0.1-0.25 mm.

13. A method for manufacture of a doctor blade comprising the steps of:
providing a flat oblong core having at least one inner layer;
arranging two plastic layers on opposing main surfaces of the core, in such a way that the plastic layers project over a longitudinal side of the core;
firmly adhering the plastic layers to the core;
adhering together the plastic layers in the projecting region.

14. The method as recited in claim 13 whereas the plastic layers are attached to the core as well as joined together by laminating.
